(19) United States
(12) Patent Application Publication
(10) Pub. No.: US 2013/0111199 A1
(43) Pub. Date: May 2, 2013

(54) INFORMATION PROCESSING APPARATUS, METHOD OF SWITCHING BETWEEN STARTUP MODES OF INFORMATION PROCESSING APPARATUS, AND RECORDING MEDIUM

(71) Applicant: SONY CORPORATION, Tokyo (JP)

(72) Inventor: Hiromitsu WATANABE, Kanagawa (JP)

(73) Assignee: SONY CORPORATION, Tokyo (JP)

(21) Appl. No.: 13/659,246

(22) Filed: Oct. 24, 2012

(30) Foreign Application Priority Data
Oct. 31, 2011 (JP) 2011-238952

(51) Int. Cl. G06F 9/00

(52) U.S. Cl. 713/1

(57) ABSTRACT

There is provided an information processing apparatus including a determination unit for determining whether a state of the information processing apparatus satisfies a predetermined condition, the state of the information processing apparatus including a normal startup mode and a fast startup mode which is used for starting up faster than the normal startup mode, and a switching unit for switching between startup modes during a second or subsequent startup of the information processing apparatus, from the fast startup mode to the normal startup mode, depending on a determination result.

### BACKGROUND

The present disclosure relates to an information processing apparatus, a method of switching between startup modes of the information processing apparatus, and a recording medium.

Recently, a variety of techniques have been proposed to reduce a period of time taken for an information processing apparatus to start up. For example, Japanese Patent Application Laid-Open Publication No. 2008-165588 discloses an image processing apparatus which starts up in a normal startup mode at the time of the first startup. This image processing apparatus, when operating at the time of the second or subsequent startup, can start up at a high speed by not performing some of the processes which would be performed at the time of the first startup.

### SUMMARY

However, in some cases, a more stable startup may be achieved in a normal startup mode rather than in a fast startup mode, depending on the state of an information processing apparatus.

In view of this circumstance, it is desirable to switch the second or subsequent startup mode from a fast startup mode to a normal startup mode, provided that a predetermined condition is satisfied. Therefore, the present disclosure provides a predetermined condition for switching the startup mode to the normal startup mode.

According to an embodiment of the present disclosure, there is provided an information processing apparatus, including a determination unit for determining whether a state of the information processing apparatus satisfies a predetermined condition, the state of the information processing apparatus including a normal startup mode and a fast startup mode which is used for starting up faster than the normal startup mode, and a switching unit for switching between startup modes during a second or subsequent startup of the information processing apparatus, from the fast startup mode to the normal startup mode, depending on a determination result.

According to the embodiment of the present disclosure, the startup mode of the information processing apparatus can be switched from the fast startup mode to the normal startup mode, depending on the determination result obtained by using the predetermined condition based on the state of the information processing apparatus. Therefore, the startup mode of the information processing apparatus can be switched to the normal startup mode at an appropriate time, thereby improving stability during startup of the information processing apparatus.

Further, according to an embodiment of the present disclosure, there is provided a method of switching between startup modes of an information processing apparatus, the method including determining whether a state of the information processing apparatus satisfies a predetermined condition, the state of the information processing apparatus including a normal startup mode and a fast startup mode which is used for starting up faster than the normal startup mode, and switching between startup modes during a second or subsequent startup of the information processing apparatus, from the fast startup mode to the normal startup mode, depending on a determination result.

Further, according to an embodiment of the present disclosure, there is provided a program for causing a computer to function as an information processing apparatus, including a determination unit for determining whether a state of the information processing apparatus satisfies a predetermined condition, the state of the information processing apparatus including a normal startup mode and a fast startup mode which is used for starting up faster than the normal startup mode, and a switching unit for switching between startup modes during a second or subsequent startup of the information processing apparatus, from the fast startup mode to the normal startup mode, depending on a determination result.

Further, according to an embodiment of the present disclosure, there is provided a computer-readable recording medium having recorded thereon a program for causing a computer to function as an information processing apparatus including a determination unit for determining whether a state of the information processing apparatus satisfies a predetermined condition, the state of the information processing apparatus including a normal startup mode and a fast startup mode which is used for starting up faster than the normal startup mode, and a switching unit for switching between startup modes during a second or subsequent startup of the information processing apparatus, from the fast startup mode to the normal startup mode, depending on a determination result.

According to the embodiments of the present disclosure described above, it is possible to improve stability during startup of the information processing apparatus.

### BRIEF DESCRIPTION OF THE DRAWINGS

FIG. 1 is a block diagram illustrating an exemplary hardware configuration of an information processing apparatus according to an embodiment of the present disclosure;

FIG. 2 is a diagram illustrating an exemplary internal configuration of a flash memory of the information processing apparatus according to the embodiment of the present disclosure;

FIG. 3 is a flowchart showing a startup operation of the information processing apparatus according to the embodiment of the present disclosure;

FIG. 4 is a flowchart showing a first example of a startup mode switching operation of the information processing apparatus according to the embodiment of the present disclosure;

FIG. 5 is a flowchart showing a second example of the startup mode switching operation of the information processing apparatus according to the embodiment of the present disclosure;

FIG. 6 is a table showing a relationship between the number of continuous fast startup times and a threshold of startup time, the relationship being used by the the information processing apparatus according to the embodiment of the present disclosure;

FIG. 7 is a flowchart showing a third example of the startup mode switching operation of the information processing apparatus according to the embodiment of the present disclosure;

FIG. 8 is a flowchart showing a fourth example of the startup mode switching operation of the information processing apparatus according to the embodiment of the present disclosure;

FIG. 9 is a table showing a relationship between the number of continuous fast startup times and a threshold of image size, the relationship being used by the the information processing apparatus according to the embodiment of the present disclosure; and

FIG. 10 is a flowchart showing a fifth example of the startup mode switching operation of the information processing apparatus according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will he made in the following order.

1. Overview

2. Configuration of Apparatus

3. Startup Operation

4. Operation for Switching to Normal Startup Mode
4-1. First Example (Example of using the number of continuous fast startup times)
4-2. Second Example (Example of using a startup time)
4-3. Third Example (Example of the case where an exception handling is occurred)
4-4. Fourth Example (Example of using an image size)
4-5. Fifth Example (Example of using a fragmentation size)

5. Conclusion

### 1. OVERVIEW

In an information processing apparatus, a startup mode called a warm boot or hot boot is used. In such startup mode, the startup is done without performing a portion (for example, hardware initialization) of the processes which would be performed in a normal startup mode, also called a cold boot. Therefore, the warm boot or hot boot generally has a shorter period of time taken to startup as compared to the cold boot. The warm boot or hot boot is called as a fast startup mode, whereas the cold boot is called as the normal startup mode.

The period of time taken to startup becomes a waiting time for the user. Thus, the fast startup mode is effective from a user convenience point of view. In order to shorten the user waiting time, it may be desirable to use the fast startup mode. However, as described above, a portion of the processes which would be performed in the normal startup mode is not performed in the fast startup mode of the information processing apparatus. Thus, the continuous startup in the fast startup mode may adversely affect the stability of the information processing apparatus. In order for the information processing apparatus to be started up in a stable manner, it is desirable to use the normal startup mode. Therefore, in the information processing apparatus that uses the fast startup mode, it is desirable to switch the startup mode of the information processing apparatus to the normal startup mode using an appropriate trigger, thereby ensuring a stable startup.

The present disclosure provides a plurality of triggers which are used to switch a startup mode of the information processing apparatus from the fast startup mode to the normal startup mode. In the following, exemplary methods of switching from a warm boot to a cold boot will be described; however, the present disclosure is not limited to the exemplary methods. The warm boot is started up using a Hibernation Image (also called as a WBI: Warm Boot Image) saved in a non-volatile region. For example, the present disclosure can be also applied to the case of switching from other fast startup modes such as a hot boot to the normal startup mode.

### 2. CONFIGURATION OF APPARATUS

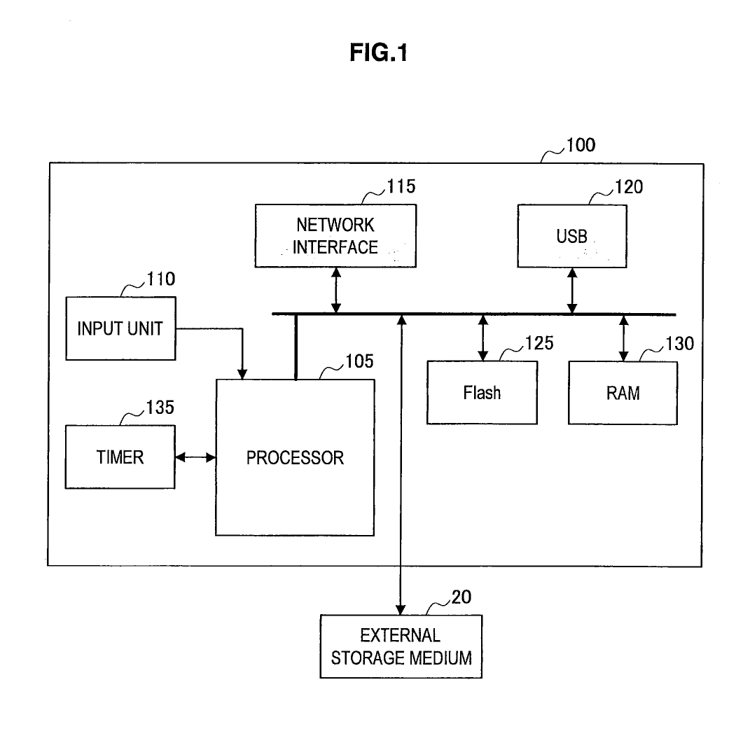

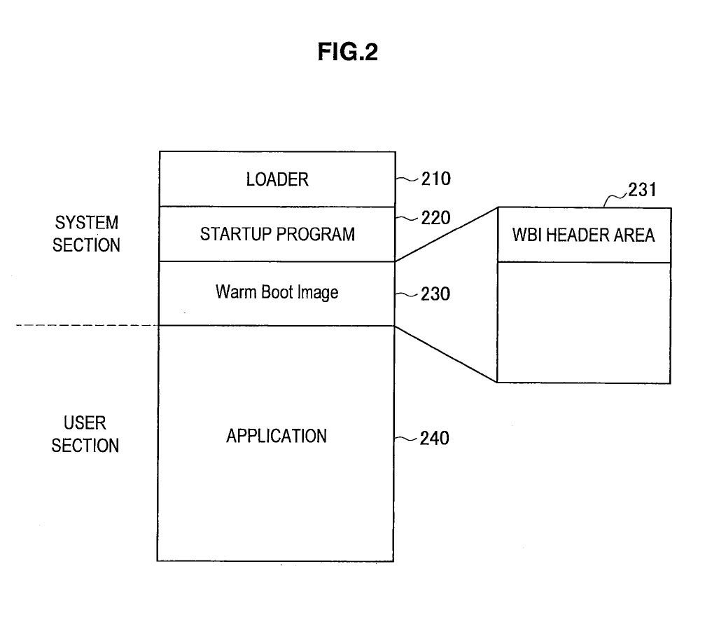

The configuration of an information processing apparatus according to an embodiment of the present disclosure will be described with reference to FIG. 1 and FIG. 2. FIG. 1 is a block diagram illustrating an exemplary hardware configuration of the information processing apparatus according to the embodiment of the present disclosure. FIG. 2 is a diagram illustrating an exemplary internal configuration of a flash memory of the information processing apparatus according to the embodiment of the present disclosure.

Referring to FIG. 1, the information processing apparatus 100 according to the embodiment of the present disclosure mainly includes a processor 105, an input unit 110, a network interface 115, a USB 120, a Flash 125, a RAM 130, and a timer 135. USB means Universal Serial Bus, and RAM means Random Access Memory.

Examples of the information processing apparatus 100 include a PC, a home video processing device (DVD recorder, video cassette recorder and the like), a home game machine, a household electrical appliance, a PDA, a mobile phone, a PHS, a portable music player, a portable video processing device, a portable game machine, an image pickup device, and a navigator. PC means Personal Computer, DVD means Digital Versatile Disk, PDA means Personal Data Assistance, PHS means Personal Handyphone System.

(Processor 105)

The processor 105 is a processing unit for controlling the overall operation of the information processing apparatus 100 by executing software. The processor 105 may include an arithmetic and logic unit, a register, and a peripheral circuit. A representative example of the processor may be a CPU. CPU means Central Processing Unit. The processor 105 may be examples of a determination unit and a switching unit. The processor 105 can serve as a determination unit and a switching unit by executing a given program.

The processor 105 that serves as determination unit can determine whether a state of the information processing apparatus 100 satisfies a predetermined condition. The predetermined condition will be described later. The processor 105 serving as switching unit can switch the startup mode at a time when the information processing apparatus 100 performs the second or subsequent startup from a warm boot to a cold boot, according to the result obtained from the determination. A variety of methods can be employed to enable the processor 105 to switch between the startup modes. For example, the processor 105 can perform the startup mode switching from a warm boot to a cold boot by preventing the WBI from being read out. In addition, the processor 105 may be set so that the second or subsequent startup mode is forcibly switched from a warm boot to a cold boot. The WBI may be an example of a startup image used for a fast startup. In the following description, an example of performing the switching between startup modes by discarding the WBI will be described.

(Input Unit 110)

The input unit 110 may be a device for generating an input signal to perform user's desired operations, and may include a button, a touch panel, a mouse, a keyboard, a switch, a lever, a microphone, and so on.

(Network Interface 115)

The network interface 115 may be an interface for connecting the apparatus to a network. The information processing apparatus 100 can be connected to an external information processing apparatus through the network interface 115.

(USB 120)

The USB 120 may be a female connector compliant with the USB specification. A male connector compliant with the USB specification may be inserted into the USB 120. For example, a UBS cable having a male connector compliant with the USB specification may be inserted into the USB 120. The information processing apparatus 100 may be connected to other information processing apparatus through the UBS cable and the USB 120 which is a female connector.

(Flash 125)

The Flash 125 may be an example of a storage unit used as an internal storage region of the information processing apparatus 100. In addition, the Flash 125 may be a non-volatile storage region for storing the WBI therein. An exemplary internal configuration of the Flash 125 will be described later with reference to FIG. 2.

(RAM 130)

The RAM 130 may be a main memory of the information processing apparatus 100. The RAM 130 can temporarily store programs, parameters, and so on. The programs are used by the processor 105, and the parameters are suitably selectable when executing the programs.

(Timer 135)

The timer 135 can measure an elapsed time. The timer 135 can measure a startup time and a shutdown time of the information processing apparatus 100. The startup time or shutdown time measured by the timer 135 is used to determine a trigger for switching the startup mode of the information processing apparatus 100 from a fast startup mode to a normal startup mode. The determination of the trigger will be described later.

(External Storage Medium 20)

The information processing apparatus 100 can store data to the external storage medium 20 by connecting to the external storage medium 20 through a connector.

Referring to FIG. 2, an internal configuration of the Flash 125 will now be described. The Flash 125 may be largely divided into two sections: a system section and a user section. The system section includes a loader region 210, a startup program region 220, and a WBI saving region 230. Data necessary to startup is loaded into the loader region 210. The user section 240 is mainly used to save data such as applications.

In a head portion of the WBI saving region 230, a WBI header area 231 may be formed. There will be described a process where the information processing apparatus 100 selects between startup modes depending on whether there is a WBI. The determination as to whether there is a WBI may be performed on the basis of whether the format of the WBI header area is correct. Therefore, the processor 105 serving as switching unit can discard the WBI and switch the second or subsequent startup mode to a cold boot. Discarding the WBI is performed by removing the WBI header area 231 with data used to break the format of the WBI.

The exemplary hardware configuration of the information processing apparatus 100 according to the embodiment of the present disclosure has been described. However, the configuration described above is merely an illustrative example, and the configuration to be utilized can be modified appropriately according to a technical level at the time of implementing the embodiment. A portion of the components may be deleted, or additional components may be included.

Functions according the embodiments of the present disclosure may be realized by creating a computer program for implementing any operations of the information processing apparatus 100 described below and by causing the processor 105 of the information processing apparatus 100 to execute the program. In addition, a computer-readable recording medium having such computer program stored thereon may be provided. The recording medium may include a magnetic disk, an optical disk, a magneto-optical disk, a flash memory, and so on. Furthermore, the computer program may be distributed through a network without using the recording medium.

### 3. STARTUP OPERATION

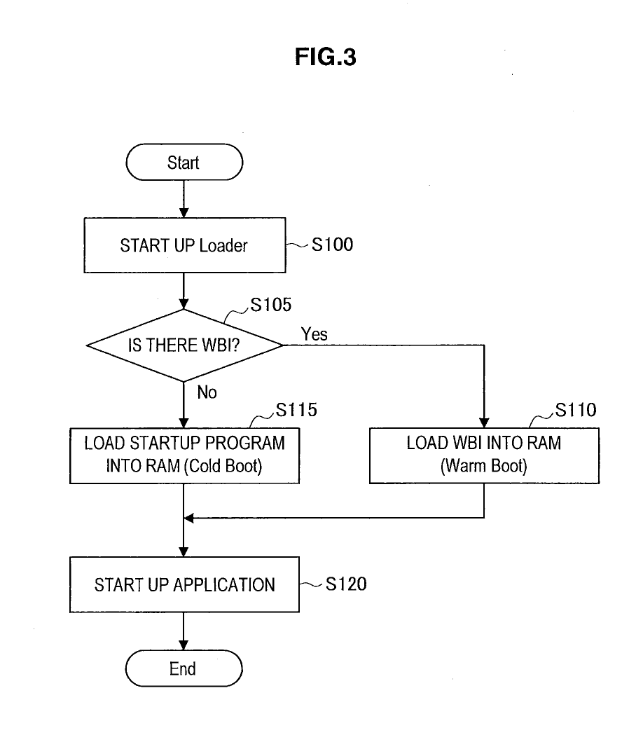

A startup sequence of the information processing apparatus 100 according to the embodiment of the present disclosure will be described with reference to FIG. 3. FIG. 3 is a flowchart showing a startup operation of the information processing apparatus according to the embodiment of the present disclosure.

Referring to FIG. 3, if a startup trigger of the information processing apparatus 100 is detected, a loader is started up (S100). The loader checks whether there is a WBI in the WBI saving region 230 (S105). The determination as to whether there is a WBI may be performed by allowing the loader to analyze the format of the WBI header area 231 provided in the header portion of the WBI saving region 230. If the format of the WBI header area 231 is correct, the loader may determine that there is a WBI. If the format of the WBI header area 231 is incorrect, the loader may determine that there is no WBI.

In the determination of step 105, if it is determined that there is a WBI, the loader loads the WBI into the RAM 130 to perform a warm boot (S110). On the other hand, in the determination of step 105, if it is determined that there is no WBI, the loader loads a startup program into the RAM 130 to perform a cold boot (S115). Then, an application is started up (S120), and the entire system is started up.

The startup sequence of the case where a warm boot is performed using the WBI has been described. Switching from a fast startup mode to a non-nal startup mode will be described. Such switching may be one of main techniques of the present disclosure. A continuous fast startup mode may be a warm boot using the WBI. A trigger for switching from a worm boot to a cold boot will be described by using a plurality of examples.

### 4. OPERATION FOR SWITCHING TO NORMAL STARTUP MODE

### 4-1. FIRST EXAMPLE

### Example of Using the Number of Continuous Fast Startup Times

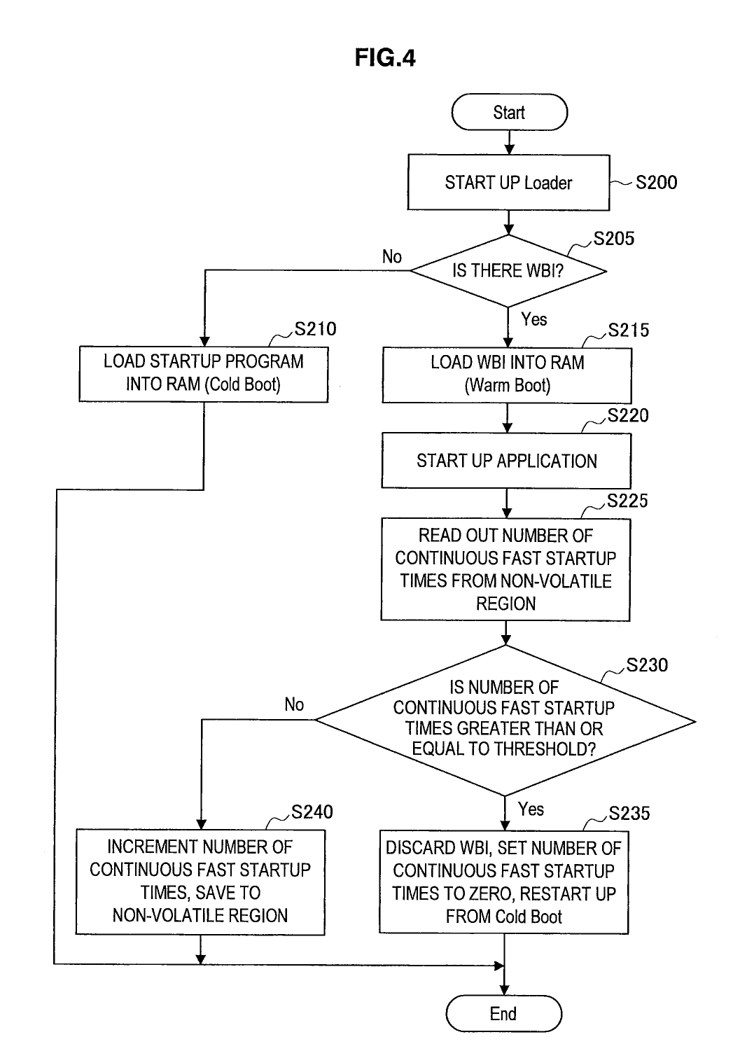

The first example of the switching operation for switching the startup mode of the information processing apparatus 100 from the fast startup mode to the normal startup mode will be described with reference to FIG. 4. The first example employs the number of continuous fast startup times. FIG. 4 is a flowchart showing the first example of the startup mode switching operation of the information processing apparatus according to the embodiment of the present disclosure.

Referring to FIG. 4, the determination as to whether the second or subsequent startup mode is switched from a warm boot to a cold boot is performed at the time when the information processing apparatus 100 is started up. This determination, in the first example, is based on the number of continuous fast startup times.

When a startup trigger of the information processing apparatus 100 is detected, a loader is started up (S200). Then, the loader determines whether there is a WBI (S205). The determination as to whether there is a WBI in step S205 may be performed by a method similar to that performed in the determination of step S105. If it is determined that there is no WBI based on the determination in step 5205, the loader loads a startup program into the RAM 130 to perform the cold boot (S210).

On the other hand, if it is determined that there is a WBI based on the determination in step 5205, the loader loads the WBI into the RAM 130 to perform a warm boot (S215). Then, an application is started up (S220), and thus the entire system is started up.

The processor 105 serving as determination unit reads out the number of continuous fast startup times from a non-volatile region of the information processing apparatus 100 (S225). The number of continuous fast startup times may be the number of times the information processing apparatus 100 has been continuously started up from a warm boot. If the information processing apparatus 100 is started up from a cold boot, the number of continuous fast startup times is set to zero.

The processor 105 serving as determination unit determines whether the number of continuous fast startup times is greater than or equal to a predetermined threshold (S230). As the number of continuous fast startup times is increased, the information processing apparatus 100 becomes more likely to be started up in an unstable manner. Therefore, the threshold may be set based on the possibility that the information processing apparatus 100 will perform a stable startup.

In the determination of step S230, if it is determined that the number of continuous fast startup times is greater than or equal to the predetermined threshold, the processor 105 serving as determination unit discards the WBI and sets the number of continuous fast startup times to zero. The information processing apparatus 100 is then restarted up from a cold boot (S235).

Meanwhile, in the determination of step S230, if it is not determined that the number of continuous fast startup times is greater than or equal to the predetermined threshold, the processor 105 increments the number of continuous fast startup times and saves it to the non-volatile region (S240).

In the first example, the determination as to whether the startup mode is switched to a cold boot is performed on the basis of the the number of continuous fast startup times. This method has an advantage in that the WBI can be discarded in a certain cycle without the need for complicated logics. When the threshold is set to an appropriate value, there is a high possibility that the system can be maintained in a stable state.

### 4-2. SECOND EXAMPLE

### Example of Using a Startup Time

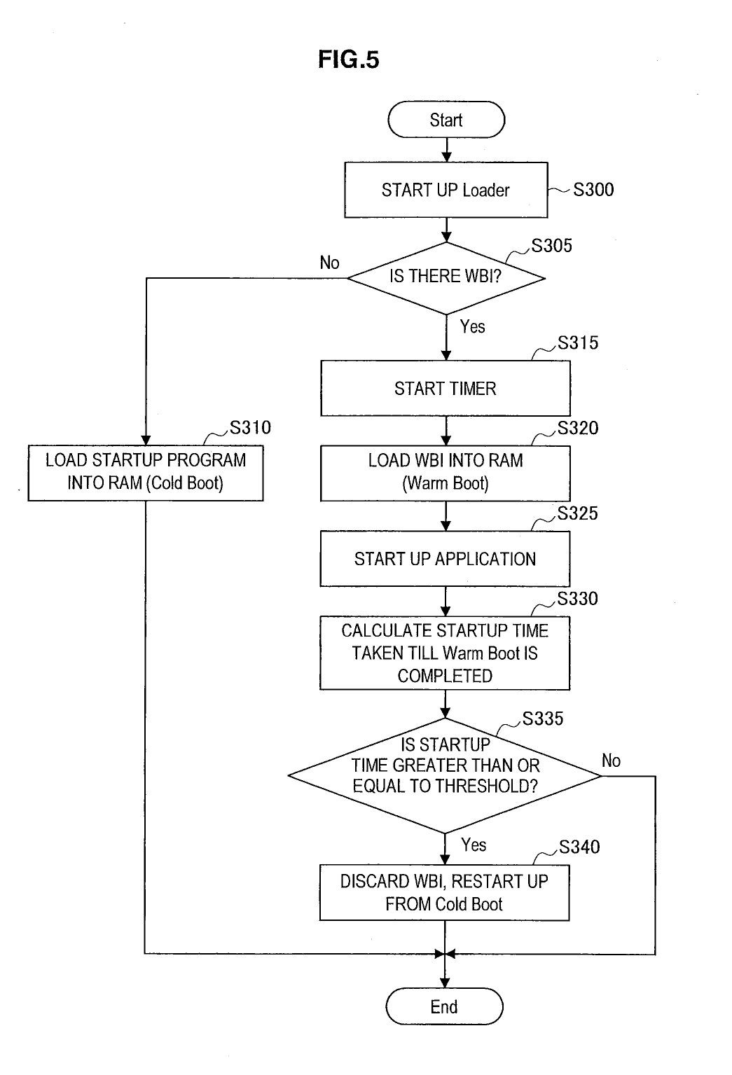

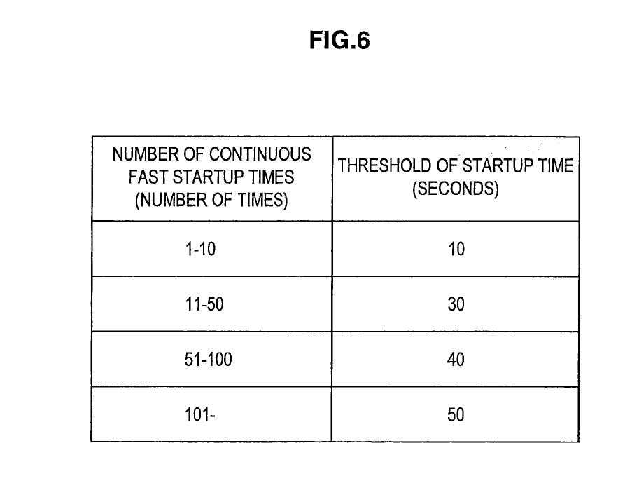

The second example of a switching operation for switching a startup mode of the information processing apparatus 100 from a fast startup mode to a normal startup mode will be described with reference to FIG. 5 and FIG. 6. FIG. 5 is a flowchart showing the second example of the startup mode switching operation of the information processing apparatus according to the embodiment of the present disclosure. FIG. 6 is a table showing a relationship between the number of continuous fast startup times and the threshold of startup time, and the relationship is used by the the information processing apparatus according to the embodiment of the present disclosure.

Referring to FIG. 5, in the second example, the determination as to whether the second or subsequent startup mode is switched from a warm boot to a cold boot is performed by measuring the period of time taken for the information processing apparatus 100 to be started up.

When a startup trigger of the information processing apparatus 100 is detected, a loader is started up (S300). The loader determines whether there is a WBI (S305). The determination as to whether there is a WBI in step S305 may be performed by a method similar to that performed in the determination of step S105 described above. If it is determined that there is no WBI based on the determination in step S305, the loader loads a startup program into the RAM 130 to perform a cold boot (S310).

On the other hand, if it is determined that there is a WBI based on the determination in step S305, the processor 105 serving as determination unit activates a timer (S315). The loader then loads the WBI into the RAM 130 to perform a warm boot (S320). An application is then started up (S325), and thus the entire system is started up.

Next, the processor 105 serving as determination unit calculates (S330) a period of time taken from when the startup is activated by the timer to when the warm boot is completed (this period of time is referred to as “startup time”). The processor 105 serving as determination unit determines whether the calculated startup time is greater than or equal to a predetermined threshold (S335).

In the determination of step S335, if it is determined that the startup time is greater than or equal to the predetermined threshold, the processor 105 serving as switching unit discards the WBI. The information processing apparatus 100 is then restarted up from a cold boot (S340).

As described above, in the second example, the determination as to whether the startup mode is switched to a cold boot is performed on the basis of the startup time. When the determination is based on the startup time, the state where a warm boot cannot be started up in a fast manner is determined based on a direct parameter of the startup time. Therefore, when the WBI is no longer used for a fast startup, transition to the more stable state is achievable by a cold boot.

A fixed value or a variable value may be used as the threshold of the startup time. For example, there is a high possibility of a correlation between the number of continuous fast startup times and the startup time. As the number of continuous fast startup times becomes small, there is a tendency for the startup time to be shorter. Therefore, when a long time is taken for the startup, even though the number of continuous fast startup times is small, there is a high possibility of causing some other problems. Accordingly, a value that is changed according to the number of continuous fast startup times may be used as the threshold of the startup time. In the example shown in FIG. 6, the threshold of the startup time changed according to the number of continuous startup times may be used. For example, in the case where the number of continuous startup times ranges from 1 to 10 times, the threshold of the startup time may be 10 seconds. In the case where the number of continuous startup times ranges from 11 to 50 times, the threshold of the startup time may be 30 seconds. In the case where the number of continuous startup times ranges from 51 to 100 times, the threshold of the startup time may be 40 seconds. In the case where the number of continuous startup times is greater than or equal to 101 times, the threshold of the startup time may be 50 seconds.

### 4-3. THIRD EXAMPLE

### Example of the Case Where an Exception Handling is Occurred

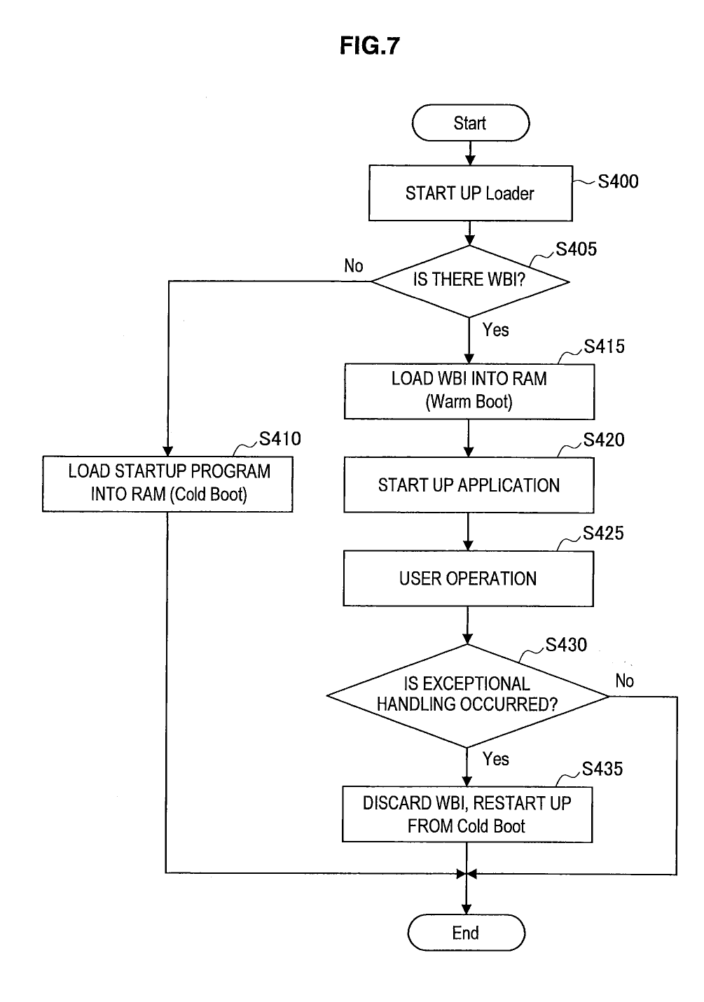

The third example of the switching operation for switching a startup mode of the information processing apparatus 100 from a fast startup mode to a normal startup mode will be described with reference to FIG. 7. The third example is an example of the case where an exception handling is occurred. FIG. 7 is a flowchart showing the third example of a startup mode switching operation of the information processing apparatus according to the embodiment of the present disclosure.

Referring to FIG. 7, the third example shows the startup mode switching of the case where an exception handling is occurred in the information processing apparatus 100.

When a startup trigger of the information processing apparatus 100 is detected, the loader is started up (S400). The loader determines whether there is a WBI (S405). The determination as to whether there is a WBI in step S405 may be performed by a method similar to that performed in the determination of step 5105 described above. If it is determined that there is no WBI based on the determination in step 5405, the loader loads a startup program into the RAM 130 to perform a cold boot (S410).

On the other hand, if it is determined that there is a WBI based on the determination in step 5405, the loader loads the WBI into the RAM 130 to perform a warm boot (S415). An application is then started up (S420), and a user operation is started (S425).

If the user continues to use the information processing apparatus 100, this may cause the system to potentially malfunction. In such case, the information processing apparatus will mostly fall into the state of exceptional handling such as a freeze or no response of the information processing apparatus. The processor 105 serving as determination unit determines whether the exceptional handling is occurred (S430). In the determination of step 5430, if it is determined that the exceptional handling is occurred, the processor 105 serving as switching unit discards the WBI. The information processing apparatus 100 is then restarted up from a cold boot (S435).

The WBI of the information processing apparatus 100 in which the exceptional handling is occurred is more likely to be an abnormal state as a data. For this reason, even when the WBI is used, it is difficult to assure the information processing apparatus 100 operates in a stable manner. Therefore, it is desirable to discard the WBI, perform a cold boot, and re-create a new WBI, at the time when the exceptional handling is occurred. This enables the startup of the system to be performed in a more stable manner.

### 4-4. FOURTH EXAMPLE

### Example of Using an Image Size

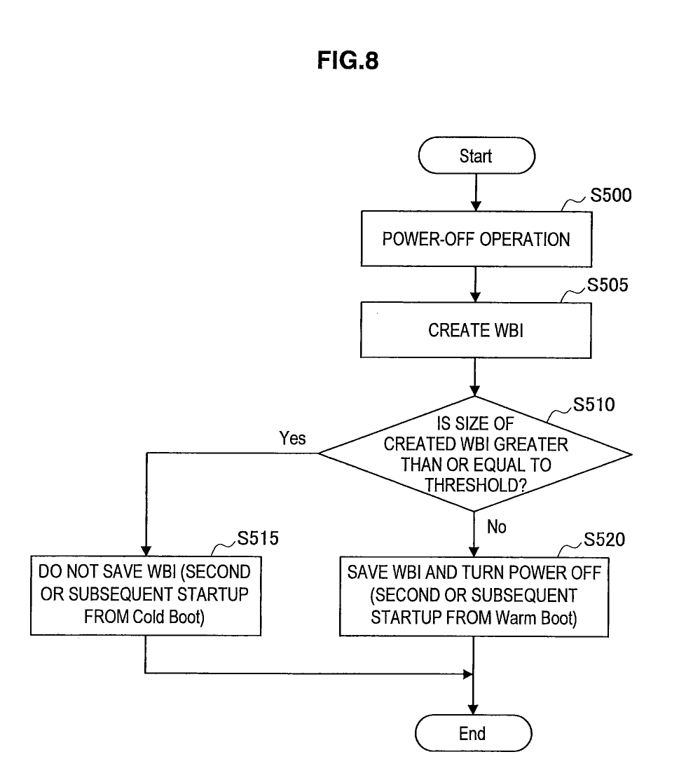

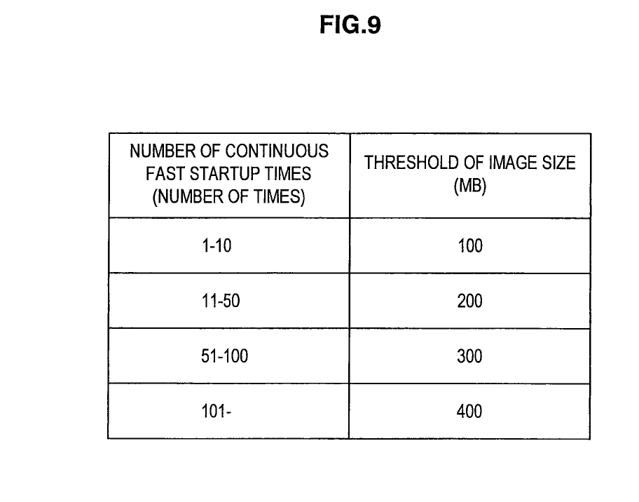

The fourth example of the switching operation for switching a startup mode of the information processing apparatus 100 from a fast startup mode to a normal startup mode will be described with reference to FIG. 8 and FIG. 9. The fourth example is an example of the case where the image size of a startup image is used. FIG. 8 is a flowchart showing the fourth example of a startup mode switching operation of the information processing apparatus according to the embodiment of the present disclosure. FIG. 9 is a table showing a relationship between the number of continuous fast startup times and a threshold of image size, and the relationship is used by the the information processing apparatus according to the embodiment of the present disclosure.

Referring to FIG. 8, in the fourth example, the determination as to whether the second or subsequent startup mode is switched from a warm boot to a cold boot is performed at the time when the information processing apparatus 100 is turned off, and this determination is based on the size of the WBI of the information processing apparatus 100.

When the power-off operation is detected (S500), the processor 105 creates a WBI (S505). The processor 105 serving as determination unit determines whether the size of the created WBI is greater than or equal to a predetermined threshold (S510).

In the determination of step 5510, if it is determined that the size of the created WBI is greater than or equal to the predetermined threshold, the processor 105 does not save the created WBI (S515). Therefore, in this case, the second or subsequent startup will be performed from a cold boot.

On the other hand, in the determination of step S510, if it is not determined that the size of the created WBI is greater than or equal to the predetermined threshold, the processor 105 saves the created WBI and then turns the power off (S520). In this case, the second or subsequent startup will be performed from a warm boot using the saved WBI.

The size of the WBI changes according to usage conditions such as a memory usage at the point of time when the WBI is created. When the information processing apparatus 100 operates in a stable manner, there is no significant change in the image size of the WBI. Meanwhile, if the information processing apparatus 100 fails to operate properly, there is a tendency that the memory usage is increased and accordingly the image size is increased. Therefore, the stable startup is less likely to be achievable from a warm boot which uses the WBI with a large size of image. Thus, in the fourth example, the WBI whose image size is larger than the predetermined threshold is discarded, thereby improving the stability when the information processing apparatus 100 is started up.

The threshold of an image size which is used as a trigger may be a fixed value or a variable value. For example, the image size of the WBI of the case where the information processing apparatus 100 operates in a stable manner is more likely to be correlated with the number of continuous fast startup times. As the number of continuous startup times becomes small, the image size is more likely to be small. Therefore, a value changed according to the number of continuous fast startup times may be used as the threshold of the image size. In the example shown in FIG. 9, in the case where the number of continuous startup times ranges from 1 to 10 times, the threshold of the image size may be 100 MB. In the case where the number of continuous startup times ranges from 11 to 50 times, the threshold of the image size may be 200 MB. In the case where the number of continuous startup times ranges from 51 to 100 times, the threshold of the image size may be 300 MB. In the case where the number of continuous startup times is greater than or equal to 101 times, the threshold of the image size may be 400 MB.

### 4-5. FIFTH EXAMPLE

### Example of using a Fragmentation Size

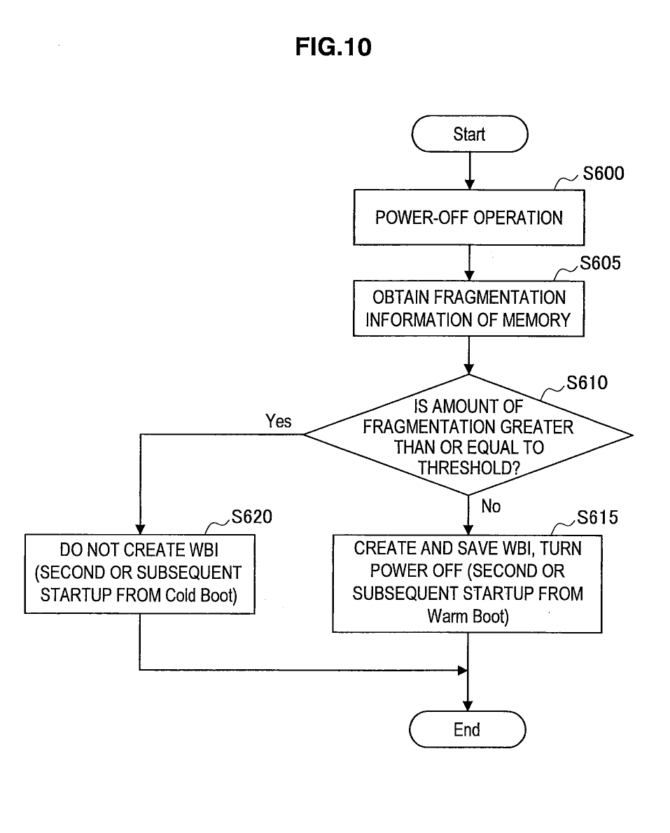

The fifth example of the switching operation for switching a startup mode of the information processing apparatus 100 from a fast startup mode to a normal startup mode will be described with reference to FIG. 10. The fifth example is an example of the case where the fragmentation size is used. FIG. 10 is a flowchart showing the fifth example of a startup mode switching operation of the information processing apparatus according to the embodiment of the present disclosure.

Referring to FIG. 10, in the fifth example, the determination as to whether the second or subsequent startup mode is switched from a warm boot to a cold boot is performed at the time when the power is turned off, based on the fragmentation size of the information processing apparatus 100.

When the power-off operation is detected (S600), the processor 105 serving as determination unit obtains fragmentation information of memory (S605). The processor 105 then determines whether the amount of fragmentation is greater than or equal to a predetermined threshold (S610).

In the determination of step S610, if it is determined that the amount of fragmentation is greater than or equal to the predetermined threshold, the processor 105 does not create a WBI. In this case, the second or subsequent startup will be performed from a cold boot.

On the other hand, in the determination of step S610, if it is not determined that the amount of fragmentation is greater than or equal to the predetermined threshold, the processor 105 creates a WBI and saves the created WBI, and then turns the power off (S615). In this case, the second or subsequent startup will be performed in a warm boot by using the saved WBI.

The amount of fragmentation has no significant change when the information processing apparatus operates normally, and this is similar to the case of using the size of the WBI. However, when the information processing apparatus fail to operate normally, the amount of fragmentation tends to be increased rapidly. Therefore, the stable startup is less likely to be achievable from a warm boot which is created at the time when the information processing apparatus fails to operate normally. Thus, in the fifth example, using the amount of fragmentation makes it possible to detect if the information processing apparatus fail to operate normally. If the amount of fragmentation has been increased, the stability when the information processing apparatus 100 is started can be improved by performing a cold boot.

### 5. CONCLUSION

The trigger for switching from a warm boot to a cold boot has been described using many examples. The information processing apparatus 100 can be started up in a stable manner by using proper one of the triggers and by switching from a warm boot to a cold boot at an appropriate time.

The determination as to whether the switch from a warm boot to a cold boot is necessary may be performed at the time when the information processing apparatus 100 is started up or at the time when the information processing apparatus 100 is turned off. The WBI is generally created as a process performed before the power is turned off. Therefore, if the determination is performed when the information processing apparatus 100 is started up, then it is possible to cause the the information processing apparatus 100 to be incapable of using the WBI by rewriting the head portion of the WBI, and the second or subsequent startup mode can be switched to a cold boot if the determination is performed when the information processing apparatus 100 is turned off, then it is possible to cause the the information processing apparatus 100 to be incapable of using the WBI by not creating or saving the WBI, and the second or subsequent startup mode can be switched to a cold boot. The method of switching to a cold boot can employ a variety different of ways, and it is not limited to methods described above.

It should be understood by those skilled in the art that various modifications, combinations, sub-combinations and alterations may occur depending on design requirements and other factors insofar as they are within the scope of the appended claims or the equivalents thereof.

For example, in the embodiments described above, the determination of switching from a warm boot to a cold boot may be performed on the basis of the number of continuous fast startup times, the startup time, whether the exception handling is occurred, the image size of startup image, and the amount of fragmentation. These conditions can be used individually or in any combination thereof.

It should be noted that, in the present specification, the steps described in the flowcharts include not only the processing executed in a time series following this order, but also processing executed in parallel or individually, which is not necessarily executed in a time series. The particular sequence of steps described is illustrative only and can be changed in any convenient or desirable order.

Additionally, the present technology may also be configured as below.
(1) An information processing apparatus including:

a determination unit for determining whether a state of the information processing apparatus satisfies a predetermined condition, the state of the information processing apparatus including a normal startup mode and a fast startup mode which is used for starting up faster than the normal startup mode; and

a switching unit for switching between startup modes during a second or subsequent startup of the information processing apparatus, from the fast startup mode to the normal startup mode, depending on a determination result.
(2) The information processing apparatus according to (1), wherein the determination unit determines whether the predetermined condition is satisfied based on a number of times the information processing apparatus has been continuously started up in the fast startup mode.
(3) The information processing apparatus according to (1) or (2), wherein the determination unit determines whether the predetermined condition is satisfied based on a startup time of the information processing apparatus.
(4) The information processing apparatus according to (3), wherein a threshold of the startup time changes depending on a number of times the information processing apparatus has been continuously started up in the fast startup mode, the startup time serving as the predetermined condition.
(5) The information processing apparatus according to any one of (1) to (4), wherein the determination unit determines whether the predetermined condition is satisfied based on whether an abnormality of the information processing apparatus is detected.
(6) The information processing apparatus according to any one of (1) to (5), wherein the determination unit determines whether the predetermined condition is satisfied based on a size of a startup image used in the fast startup mode.
(7) The information processing apparatus according to (6), wherein a threshold of the size of the startup image changes depending on a number of times the information processing apparatus has been continuously started up in the fast startup mode, the size of the startup image serving as the predetermined condition.
(8) The information processing apparatus according to any one of (1) to (7), wherein the determination unit determines whether the predetermined condition is satisfied based on a state of fragmentation of the information processing apparatus.
(9) The information processing apparatus according to any one of (1) to (8), wherein

the fast startup mode is a startup mode performing a startup by using a startup image, and

the switching unit switches to the normal startup mode by causing the startup image to be an unusable state.
(10) The information processing apparatus according to (9), wherein

the determination unit performs the determination when the information processing apparatus is turned off, and

the switching unit switches to the normal startup mode by preventing the startup image from being created.
(11) A method of switching between startup modes of an information processing apparatus, the method including:

determining whether a state of the information processing apparatus satisfies a predetermined condition, the state of the information processing apparatus including a normal startup mode and a fast startup mode which is used for starting up faster than the normal startup mode; and

switching between startup modes during a second or subsequent startup of the information processing apparatus, from the fast startup mode to the normal startup mode, depending on a determination result.
(12) A computer-readable recording medium having recorded thereon a program for causing a computer to function as an information processing apparatus including:

a determination unit for determining whether a state of the information processing apparatus satisfies a predetermined condition, the state of the information processing apparatus including a normal startup mode and a fast startup mode which is used for starting up faster than the normal startup mode; and

a switching unit for switching between startup modes during a second or subsequent startup of the information processing apparatus, from the fast startup mode to the normal startup mode, depending on a determination result.
(13) A program for causing a computer to function as an information processing apparatus including:

a determination unit for determining whether a state of the information processing apparatus satisfies a predetermined condition, the state of the information processing apparatus including a normal startup mode and a fast startup mode which is used for starting up faster than the normal startup mode; and

a switching unit for switching between startup modes during a second or subsequent startup of the information processing apparatus, from the fast startup mode to the normal startup mode, depending on a determination result.

The present disclosure contains subject matter related to that disclosed in Japanese Priority Patent Application JP 2011-238952 filed in the Japan Patent Office on Oct. 31, 2011, the entire content of which is hereby incorporated by reference.

What is claimed is:

1. An information processing apparatus comprising:
a determination unit for determining whether a state of the information processing apparatus satisfies a predetermined condition, the state of the information processing apparatus including a normal startup mode and a fast startup mode which is used for starting up faster than the normal startup mode; and
a switching unit for switching between startup modes during a second or subsequent startup of the information processing apparatus, from the fast startup mode to the normal startup mode, depending on a determination result.

2. The information processing apparatus according to claim 1, wherein the determination unit determines whether the predetermined condition is satisfied based on a number of times the information processing apparatus has been continuously started up in the fast startup mode.

3. The information processing apparatus according to claim 1, wherein the determination unit determines whether the predetermined condition is satisfied based on a startup time of the information processing apparatus.

4. The information processing apparatus according to claim 3, wherein a threshold of the startup time changes depending on a number of times the information processing apparatus has been continuously started up in the fast startup mode, the startup time serving as the predetermined condition.

5. The information processing apparatus according to claim 1, wherein the determination unit determines whether the predetermined condition is satisfied based on whether an abnormality of the information processing apparatus is detected.

6. The information processing apparatus according to claim 1, wherein the determination unit determines whether the predetermined condition is satisfied based on a size of a startup image used in the fast startup mode.

7. The information processing apparatus according to claim 6, wherein a threshold of the size of the startup image changes depending on a number of times the information processing apparatus has been continuously started up in the fast startup mode, the size of the startup image serving as the predetermined condition.

8. The information processing apparatus according to claim 1, wherein the determination unit determines whether the predetermined condition is satisfied based on a state of fragmentation of the information processing apparatus.

9. The information processing apparatus according to claim 1, wherein
the fast startup mode is a startup mode performing a startup by using a startup image, and
the switching unit switches to the normal startup mode by causing the startup image to be an unusable state.

10. The information processing apparatus according to claim 9, wherein
the determination unit performs the determination when the information processing apparatus is turned off, and
the switching unit switches to the normal startup mode by preventing the startup image from being created.

11. A method of switching between startup modes of an information processing apparatus, the method comprising:
determining whether a state of the information processing apparatus satisfies a predetermined condition, the state of the information processing apparatus including a normal startup mode and a fast startup mode which is used for starting up faster than the normal startup mode; and
switching between startup modes during a second or subsequent startup of the information processing apparatus, from the fast startup mode to the normal startup mode, depending on a determination result.

12. A computer-readable recording medium having recorded thereon a program for causing a computer to function as an information processing apparatus comprising:
a determination unit for determining whether a state of the information processing apparatus satisfies a predetermined condition, the state of the information processing apparatus including a normal startup mode and a fast startup mode which is used for starting up faster than the normal startup mode; and
a switching unit for switching between startup modes during a second or subsequent startup of the information processing apparatus, from the fast startup mode to the normal startup mode, depending on a determination result.
